(19) United States
(12) Patent Application Publication
(10) Pub. No.: US 2026/0214693 A1
(43) Pub. Date: Jul. 23, 2026

(54) METHODS AND PROCEDURES TO ENABLE PREEMPTION IN WLAN

(71) Applicant: InterDigital Patent Holdings, Inc., Wilmington, DE (US)

(72) Inventors: Mahmoud SAAD, Montreal (CA); Zinan LIN, Basking Ridge, NJ (US); Hanqing LOU, Syosset, NY (US); Xiaofei WANG, North Caldwell, NJ (US); Joseph LEVY, Merrick, NY (US); Rui YANG, Melville, NY (US)

(73) Assignee: InterDigital Patent Holdings, Inc., Wilmington, DE (US)

(21) Appl. No.: 19/134,141

(22) PCT Filed: Dec. 6, 2023
(86) PCT No.: PCT/US2023/082675

§ 371 Date: May 29, 2025

Related U.S. Application Data
(60) Provisional application No. 63/431,546, filed on Dec. 9, 2022.

(51) Int. Cl. H04W 72/563

(52) U.S. Cl. CPC H04W 72/563

(57) ABSTRACT

A station (STA) may be configured to receive a first physical layer protocol data unit (PPDU). The first PPDU may comprise a preamble that may comprise an indication indicating whether the first PPDU is preemptible. The STA may be configured to determine that the first PPDU is preemptible based on the indication and to determine that the first PPDU is interrupted. The first PPDU may be interrupted based on a termination marker. The STA may be configured to receive, in response to the first PPDU being interrupted, a second PPDU, which may comprise a preamble and carry low latency data. The STA may be configured to decode the second PPDU on a condition that the second PPDU is addressed to the STA. The indication indicating whether the first PPDU is preemptible may be carried in a preemptible subfield of a SIG field of the preamble of the first PPDU.

### CROSS-REFERENCE TO RELATED APPLICATIONS

This application claims the benefit of U.S. Provisional Application No. 63/431,546, filed Dec. 9, 2022, the contents of which are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA.

### SUMMARY

A station (STA) may be configured to receive a first physical layer protocol data unit (PPDU). The first PPDU may comprise a preamble that may comprise an indication indicating whether the first PPDU is preemptible. The STA may be configured to determine that the first PPDU is preemptible based on the indication. The STA may be configured to determine that the first PPDU is interrupted. The first PPDU may be interrupted based on a termination marker. The STA may be configured to receive, in response to the first PPDU being interrupted, a second PPDU. The second PPDU may comprise a preamble and carry low latency data. The STA may be configured to decode the second PPDU on a condition that the second PPDU is addressed to the STA. The indication indicating whether the first PPDU is preemptible may be carried in a preemptible subfield of a SIG field of the preamble of the first PPDU. The first PPDU may be determined to be interrupted on a condition that a termination marker is found during decoding of the first PPDU. The termination marker may be comprised of a set of long training field (LTF) symbols or masked LTF symbols by a known mask or function. The STA may be configured to decode the first PPDU until a termination marker is found or until an end of the first PPDU. The STA may be configured to decode each Nth symbol of a data part of the first PPDU until a termination marker is found or until an end of the first PPDU transmission. The second PPDU may be received after a time period from a termination marker, wherein the time period is a short interframe space (SIFS). The STA may be configured to receive an indication of resume or restart of the first PPDU. The STA may be configured to resume decoding of the first PPDU at a point where the first PPDU was interrupted or restart decoding of the first PPDU from a beginning based on the indication of resume or restart. The STA may be a non-access point (AP) STA.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 show an example EHT-SIG content channel format for OFDMA transmission if bandwidth is 20/40/80 MHz;

FIG. 3 show an example EHT-SIG content channel format for OFDMA transmission if bandwidth is 160 MHz;

FIG. 4 shows an example EHT-SIG content channel format for OFDMA transmission if bandwidth is 320 MHz;

FIG. 5 shows an example EHT-SIG content channel format for non-OFDMA transmission to multiple users;

FIG. 6 shows an example MU-PPDU with a Time-Domain Resource Allocation;

FIG. 7 shows an example MU-PPDU with a Time-Domain Resource Allocation in an OFDM symbol level;

FIG. 8 shows an example design of a Common field of an OFDMA transmission considering Time Domain Allocation;

FIG. 9 shows an example design of a Common field of a Non-OFDMA transmission considering Time Domain Allocation′

FIG. 10 shows an example of padding with Tg=8;

FIG. 11 shows an example of padding in a MU-PPDU;

FIG. 12 shows an example design of an Extended User field for OFDMA transmission considering

Time Domain Resource Allocation;

FIG. 13 shows an example of preemption of a PPDU to accommodate low latency traffic for two different STAs;

FIG. 14 shows an example design of a Termination Marker;

FIG. 15 shows an example design of a Termination Marker;

FIG. 16 shows an example design of Ending Marker SIG;

FIG. 17 shows example PHY transmit procedure of a preempted (or interrupted) PPDU;

FIG. 18 shows an example design of a Short Preamble for a preempting transmission;

FIG. 19 show an example design of a Long Preamble for a preempting transmission;

FIG. 20 shows an example method of a transmitter behavior;

FIG. 21 shows an example method of a transmitter behavior for a preemption procedure;

FIG. 22 shows an example method of a preempted STA receiver behavior;

FIG. 23 shows an example method of a preempting STA receiver behavior;

FIG. 24 shows an example of preemption with time-domain allocation of low latency traffic;

FIG. 25 shows an example of preemption with frequency-domain allocation (MU-PPDU) of low latency traffic;

FIG. 26 shows an example of preemption with frequency-domain and time-domain allocation (MU-PPDU) of low latency traffic;

FIG. 27 shows an example of preemption with time-domain and frequency-domain allocation (MU-PPDU) of low latency traffic;

FIG. 28 show an example of preemption with dynamic BW update of low latency traffic; and

FIG. 29 shows an example UHR-SIG.

### DETAILED DESCRIPTION

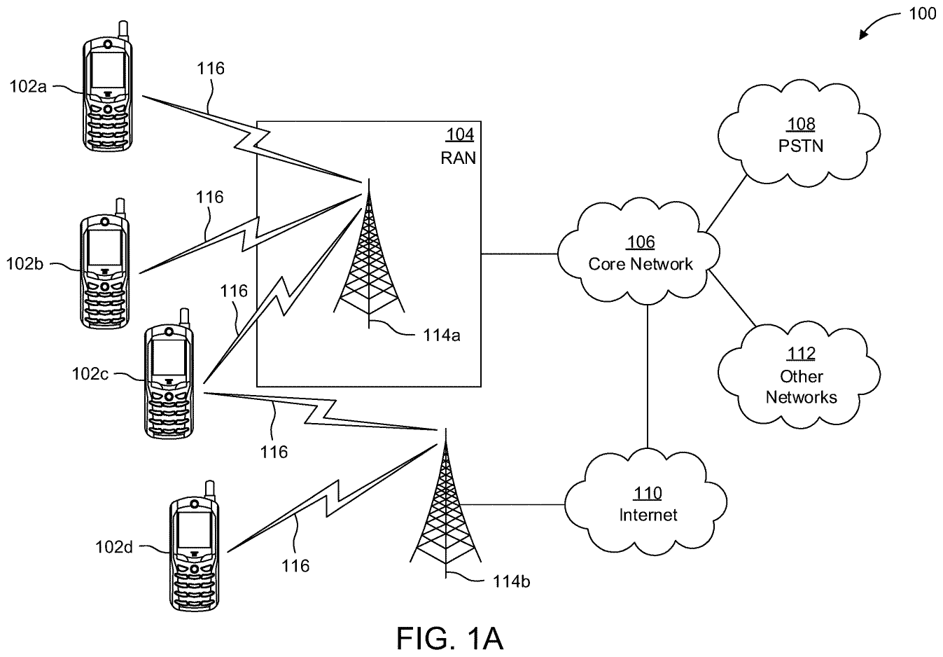

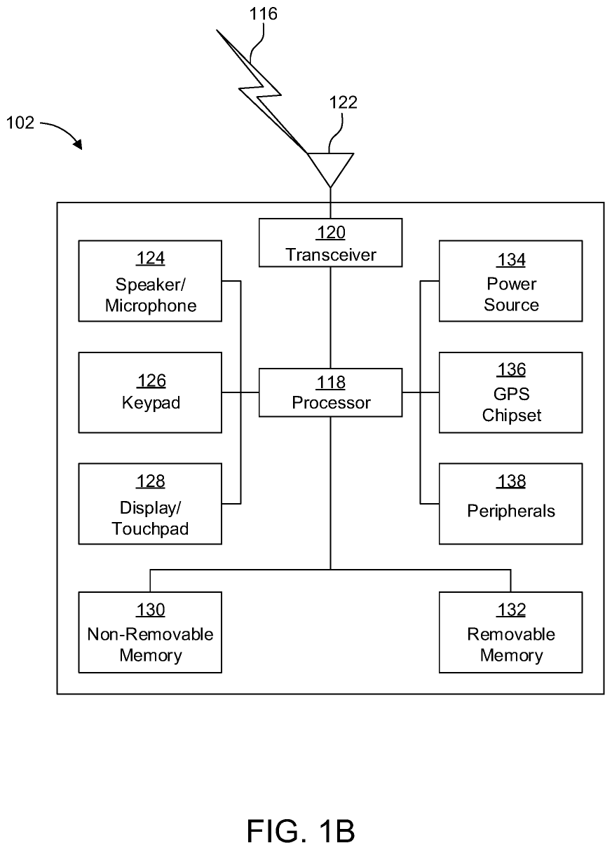

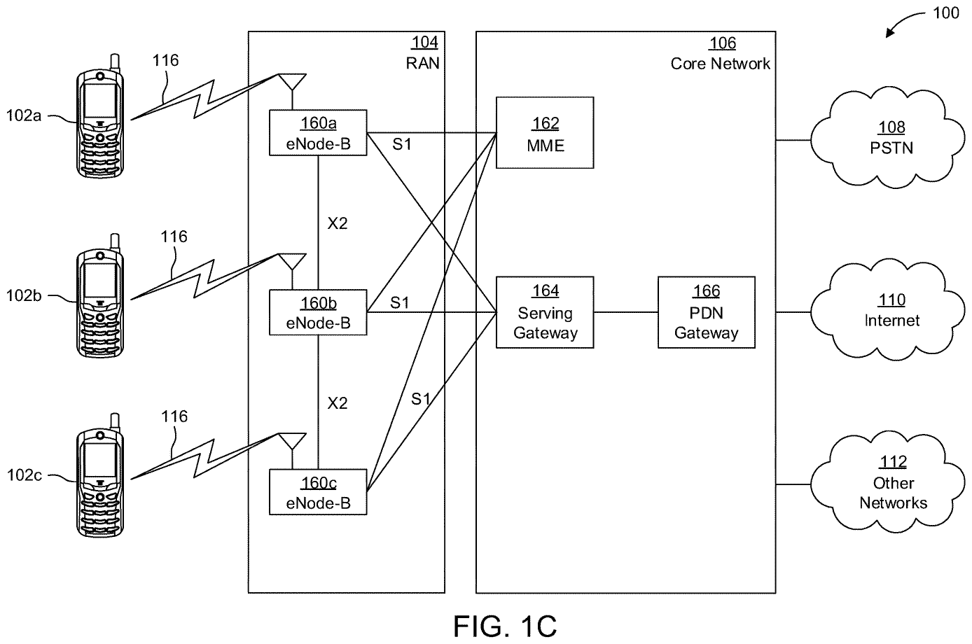

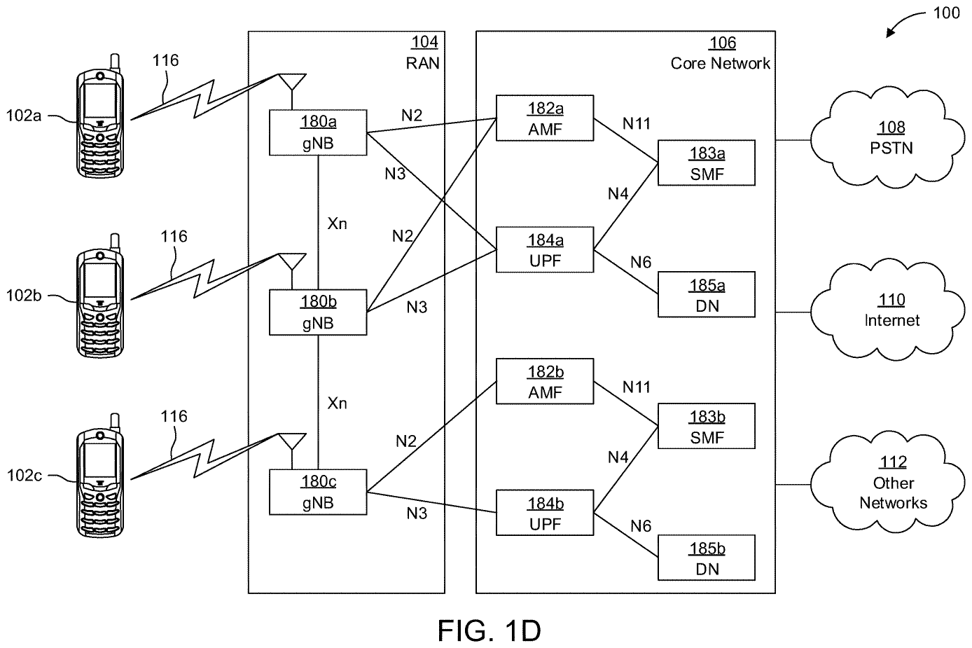

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using an 802.11ac infrastructure mode of operation, an AP may transmit a beacon on a fixed channel, such as a primary channel. This channel may be 20 MHz wide, and may be the operating channel of the BSS. This channel may also be used by the STAs to establish a connection with the AP. A channel access mechanism in an 802.11 system is Carrier Sense Multiple Access with Collision Avoidance (CSMA/CA). In this mode of operation, every STA, including the AP, may sense the primary channel. If the channel is detected to be busy, the may STA back off. Hence only one STA may transmit at any given time in a given BSS.

In 802.11n, High Throughput (HT) STAs may also use a 40 MHz wide channel for communication. This may be achieved by combining a primary 20 MHz channel with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels may be formed by combining contiguous 20 MHz channels similar to 802.11n. A160 MHz channel may be formed by combining eight contiguous 20 MHz channels or by combining two non-contiguous 80 MHz channels, which may also be referred to as an 80+80 configuration. For the 80+80 configuration, the data, after channel encoding, may be passed through a segment parser that may divide it into two streams. An inverse Discrete Fourier Transformation (IDFT) operation and time-domain processing may be done on each stream separately. The streams may then be mapped to the two channels, and the data may be transmitted. At the receiver, this procedure is reversed and the combined data may be sent to the MAC.

To improve spectral efficiency, 802.11ac introduced the concept for downlink Multi-User MIMO (MU-MIMO) transmission to multiple STAs in the same symbol's time frame, e.g., during a downlink OFDM symbol. The potential for the use of downlink MU-MIMO is also currently considered for 802.11ah. Since downlink MU-MIMO, as it is used in 802.11ac, uses the same symbol timing to multiple STAs, interference of a waveform transmissions to multiple STAs is not an issue. However, all STAs involved in MU-MIMO transmission with the AP use the same channel or band and this may limit the operating bandwidth to the smallest channel bandwidth that is supported by the STAs which are included in the MU-MIMO transmission with the AP.

A IEEE 802.11 UHR Study Group was formed in July 2022 to create a project authorization request (PAR) to create an 802.11 Task Group to standardize improved reliability of WLAN connectivity, reduce latencies, increase manageability, and increase throughput consumption. Several features are proposed to be included in the PAR such as: supporting a maximum aggregated throughput of at least 100 Gbps, supporting at least two times improvement in aggregated throughput at every signal to noise ratio (SNR) level (measured at the MAC data service access point) compared to 802.11be, defining at least one mode of operation capable of improved latency bound and jitter at the 99 to 99.9999th percentiles compared to 802.11be, satisfying real-time application requirements for high reliability in the presence of overlapping BSSs and for seamless BSS transitions within an ESS, and enabling backward compatibility and coexistence with legacy IEEE 802.11 devices operating in license-exempt bands between 1 and 7.250 GHZ and enabling coexistence with legacy IEEE 802.11 devices operating in license-exempt bands between 42.5 and 71 GHz.

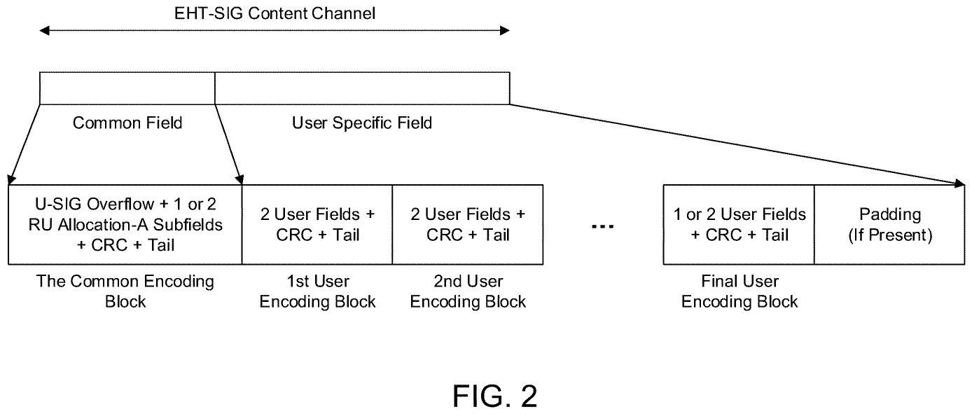

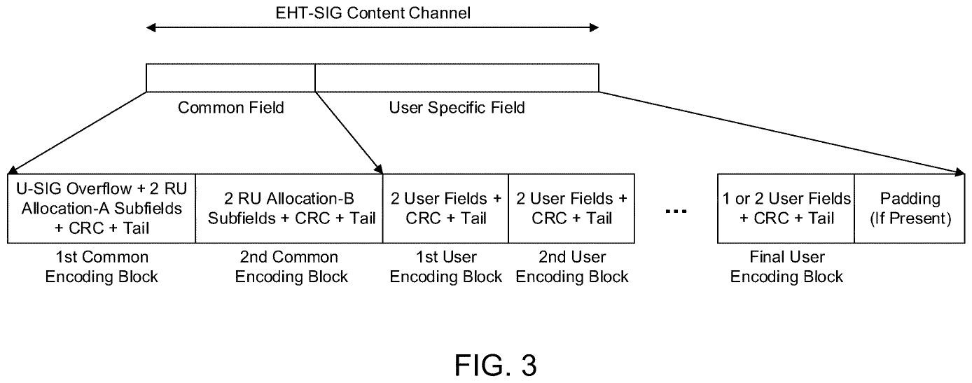

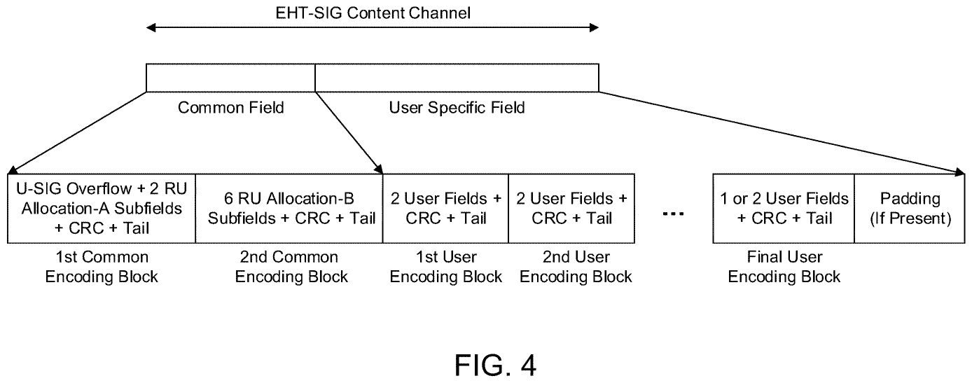

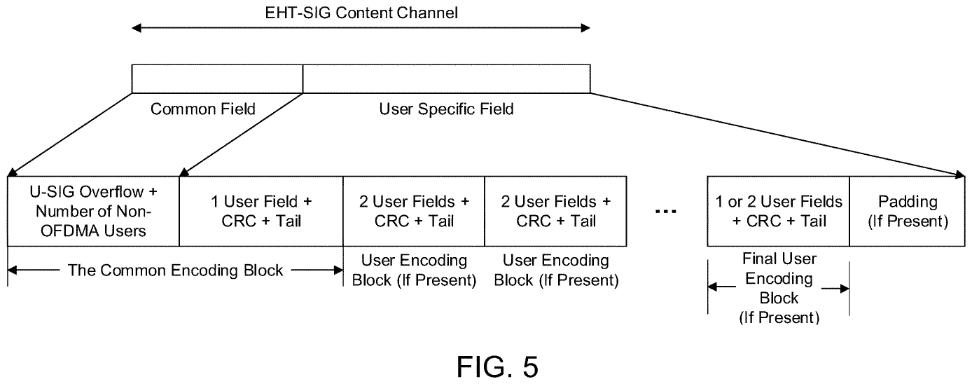

An extremely high throughput signal field (EHT-SIG) field is an example of a SIG field that is used to provide signaling for STAs to interpret the resource allocation in a physical layer protocol data unit (PPDU). The EHT-SIG field of a 20 MHz EHT MU PPDU comprises one EHT-SIG content channel. For OFDMA transmission and for non-OFDMA transmission to multiple users, the EHT-SIG field of an EHT MU PPDU that is 40 MHz or 80 MHz comprises two EHT-SIG content channels. For OFDMA transmission and for non-OFDMA transmission to multiple users, the EHT-SIG field of an EHT MU PPDU that is 160 MHz or wider contains two EHT-SIG content channels per 80 MHz frequency subblock. The EHT-SIG content channels per 80 MHz frequency subblock are allowed to carry different information when EHT MU PPDU bandwidth for OFDMA transmission is wider than 80 MHz. The EHT-SIG field of an EHT SU transmission or the EHT-SIG field of an EHT sounding NDP comprises one EHT-SIG content channel, and it is duplicated in each non-punctured 20 MHz subchannel when the EHT PPDU is equal to or wider than 40 MHz. Different examples of the EHT-SIG content channels are shown in FIG. 2, FIG. 3, FIG. 4, and FIG. 5.

FIG. 2 shows an example EHT-SIG content channel format for an OFDMA transmission if the bandwidth is 20 MHz, 40 MHz, or 80 MHz. FIG. 3 shows an example EHT-SIG content channel format for an OFDMA transmission if the bandwidth is 160 MHz. FIG. 4 shows an example EHT-SIG content channel format for an OFDMA transmission if the bandwidth is 320 MHz. FIG. 5 shows an example EHT-SIG content channel format for a non-OFDMA transmission to multiple users.

The allocation of resources to multiple users in 802.11 considers frequency domain allocation (OFDMA), spatial domain allocation (non-OFDMA) or a combination of both. Time domain allocation (TDMA) in a MU-PPDU is not defined in 802.11 and is an open problem. Discussions regarding enabling preemption behavior in a WLAN were inspiring to also enable time domain allocation of resources which may make resource allocation in a WLAN more flexible. The flexibility of resource allocation may in turn enable efficient preemption with the least waste of resources.

Low latency applications would require a fast response from the network nodes to an immediate unforeseen transmission during an ongoing transmission. In such a case, it may require the preemption of a current transmission either in the downlink or in the uplink for SU PPDUs or MU PPDUs. Preemption involves rescheduling a resource which is assigned to a STA in an ongoing transmission to reassign it to another STA which has immediate low latency traffic. Preemption behavior is not defined in 802.11 and is an open problem. Preemption of an ongoing transmission may be a straightforward method to free up resources for unforeseen low latency traffic. Although preemption of an ongoing transmission may constitute an inherent inefficiency and waste of resources, a careful design of the preemption procedure along with a flexible resource allocation scheme would allow for a tradeoff between the fast response from the network to low latency traffic arrivals and the efficient utilization of resources.

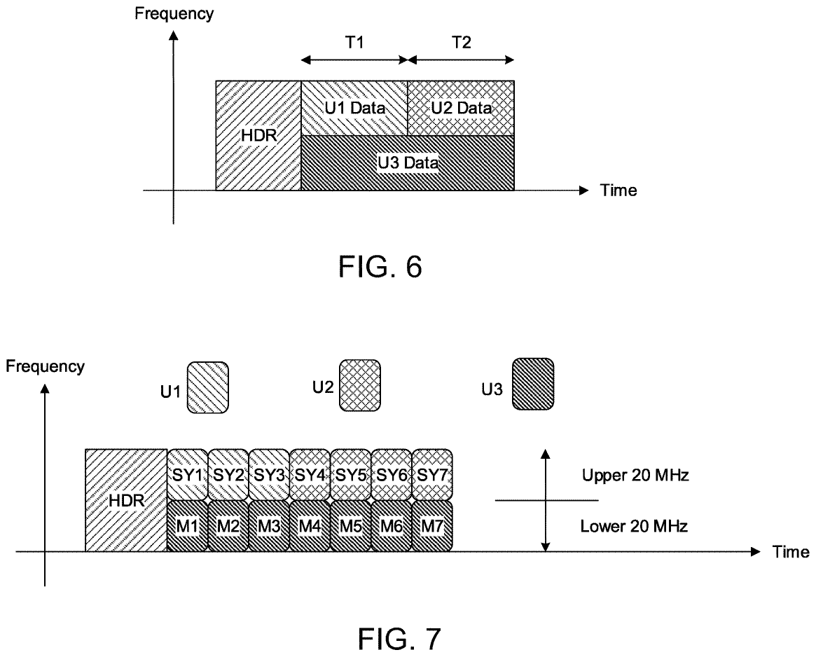

In an embodiment, a resource allocation in Multi-User PPDUs (MU-PPDUs) may consider the allocation of time domain resources in combination with the allocation of the resources in the frequency domain and/or the spatial domain. In the time domain resource allocation, a user may be allocated a time period on the same frequency resource or spatial resource which may be allocated to other users in a different time period during the same transmission. FIG. 6 shows an example of a MU-PPDU with a time domain resource allocation. Signaling information, for example in a SIG field, may indicate an allocation of a frequency resource, such as a subchannel, to a user 3 (U3) PPDU and another frequency resource, for example a different subchannel, may be allocated to two users, U1 and U2, such that the subchannel is allocated to U1 Data for the time period T1 and the subchannel is allocated to U2 Data in time period T2. The time period may be indicated as a timeslot duration or a range of time slots.

In an embodiment, the time domain resource allocation may be indicated in the SIG field as a range of OFDM symbols, as shown in FIG. 7. For example, the allocation information in the SIG field may indicate that the OFDM symbols 1 to 3 (SY1, SY2, SY3) are allocated to user U1 in the upper 20 MHz and the OFDM symbols 4 to 7 (SY4, SY5, SY6, SY7) are allocated to user U2 in the upper 20 MHz. At the same time, the OFDM symbols 1 to 7 are allocated to user U3 in the lower 20 MHz (M1 . . . . M7).

In an embodiment, an AP that allocates resources in a MU-PPDU in a downlink transmission may allocate the resources such that the non-AP STAs with small packets are grouped together on the same frequency resource but allocated different OFDM symbols. The AP may process the OFDM symbols such that the data bits from different users are modulated to different OFDM symbols and the allocation corresponding to each STA may then be signaled in a SIG field(s) in the preamble of the MU-PPDU.

In an embodiment, a timeslot duration may be indicated in terms of time units (e.g. microseconds or milliseconds) or a range of OFDM symbols. The time allocation may be indicated as relative to a reference time point which may be signaled, for example, in a beacon frame or a management frame. It may also be signaled in the SIG field where the resource allocation is taking place. Additionally or alternatively, the time allocation may be indicated as relative to the start of the data part of the PPDU.

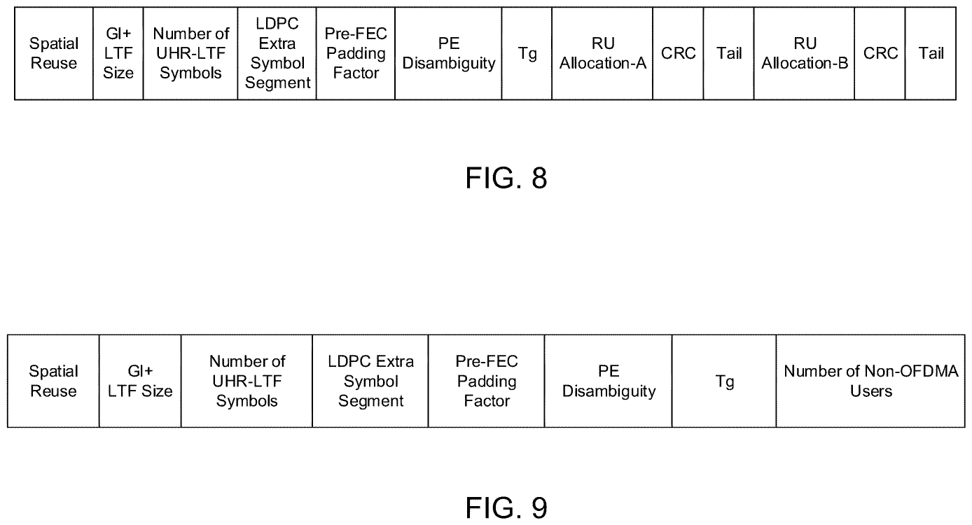

In an embodiment, a system parameter Tg may be signaled, for example, in an UHR-SIG field to indicate the granularity of the time slot duration in terms of the number of OFDM symbols in each time slot. In an example, Tg=4 indicates that each time slot is comprised of 4 OFDM symbols. The parameter Tg may be signaled, for example, in a Common field in the UHR content channel as shown in FIG. 8 for an OFDMA transmission and in FIG. 9 for a non-OFDMA transmission.

In an embodiment, the Tg parameter may be encoded such that each value for the parameter corresponds to a different granularity (e.g. a different duration of the time slot in terms of the number of OFDM symbols). Table 1 shows an example of a 3-bit encoding of the Tg parameter.

TABLE 1
Example 3-bit Encoding of the Tg Parameter

| Tg field Value | The Number of OFDM Symbols per Timeslot |
|---|---|
| 000 | Reserved |
| 001 | 1 |
| 010 | 2 |
| 011 | 4 |
| 100 | 16 |
| 101 | 32 |
| 110 | 64 |
| 111 | Reserved |

In an embodiment, different Tg values may be used in different scenarios to allow for efficient resource allocation. In an example, small values of Tg may be used in case of small packets and large values of Tg may be used in case of large packets.

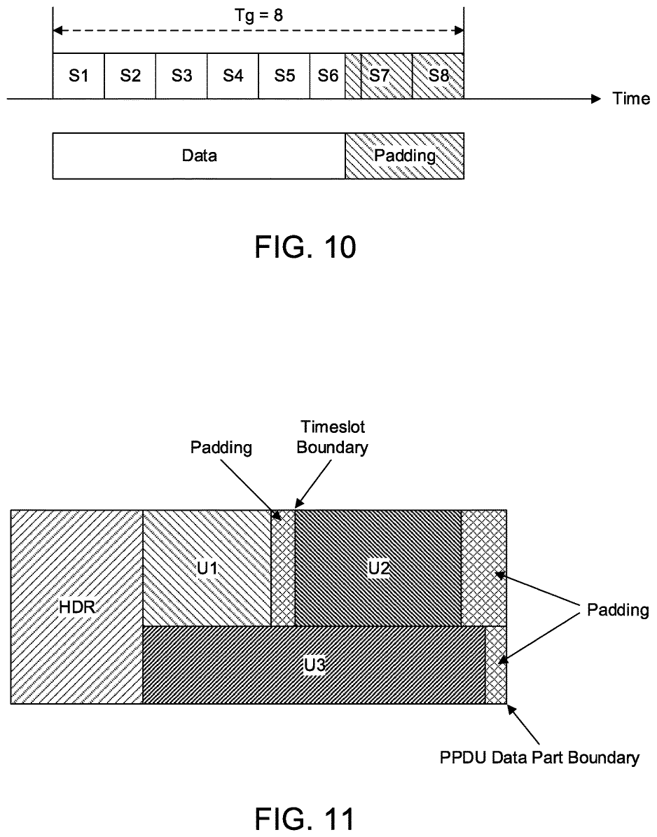

In an embodiment, time domain padding with a sequence of bits or entire OFDM symbols may be considered to pad the data transmitted in a timeslot to the timeslot boundary. The padding may be required in the last timeslot of a range of timeslots allocated to a given user. In an example, if Tg=8 (i.e., timeslot duration is 8 OFDM symbols) and the data only needs five complete OFDM symbols (e.g. S1, S2, S3, S4, S5) and a part of the 6th symbol (S6), then padding may be used to pad the remaining part of the 6th OFDM symbol and two padding OFDM symbols may be used to pad the data to the boundary of the timeslot, as shown in FIG. 10.

In an embodiment, padding of a MU-PPDU with time-domain resource allocations may take place by adding padding bits or entire OFDM symbols to the end of the data part of each user in the timeslots range allocated to it. In an example, as shown in FIG. 11, the resource allocation for each user may be larger than the required resource to accommodate the data and padding may be required to align the data transmitted to the timeslot boundary of the corresponding timeslot range. In this example, the hatched areas are the padding inserted to the corresponding data U1, U2, and U3 to align it to the timeslot boundary (as in the case of U1) or to the boundary of the data part of the PPDU (as in the case of U2 and U3).

In an embodiment, a non-AP STA that receives an MU-PPDU with time domain allocations may decode the SIG field(s) to extract the allocation information and prepare for the reception of the data part according to the allocation indicated in the SIG field(s). The non-AP STA may receive and decode the OFDM symbols allocated by the AP on the subchannel(s) and/or the spatial streams indicated in the resource allocation information in the SIG field(s).

In an embodiment, the time structure of the time-domain may be defined in terms of OFDM symbols or may be defined in terms of timeslots each with a certain time duration (e.g., microseconds or milliseconds) or in terms of timeslots each with a predefined number of OFDM symbols.

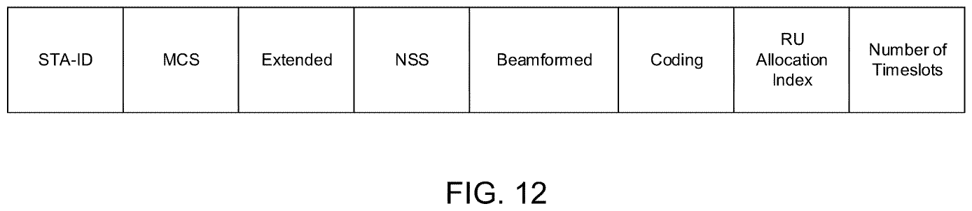

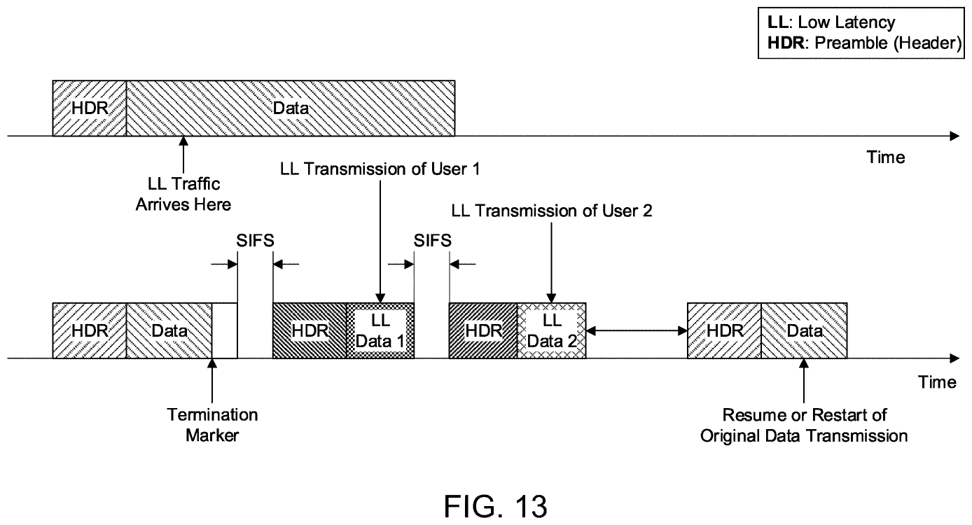

In an embodiment, the duration of the data part of a PPDU may be divided into a set of timeslots each comprised of Tg OFDM symbols. The resource allocation for the time domain resources may then be specified in terms of timeslots by allocating a range of timeslots to each scheduled user in the PPDU. The allocation may be signaled in, for example, the SIG field(s) in the preamble of the PPDU. Each scheduled STA may be allocated one or more timeslots in the same or different RUs or MRUs in the same or different spatial streams. The allocation of resources may constitute any combination of timeslots and RUs or MRUs and spatial streams. A User field in a UHR-SIG may be defined by adding new subfields to a EHT-SIG. For example, an Extended subfield, a RU Allocation Index subfield, and a Number of Timeslots subfield may be added. FIG. 12 shows an example design of an Extended User field for OFDMA transmission considering a time domain resource allocation

In an embodiment, the Extended subfield may use the Reserved bit in the EHT-SIG User field to indicate that the User field is an extended version of the User field which may also comprise time-domain resource allocation information. If the Extended field is set to a value for example set to a value of 1, the User field may be extended in size to comprise two more subfields, for example, a RU Allocation Index subfield and a Number of Timeslots subfield.

In an embodiment, the RU Allocation Index subfield may be included in the User field to indicate to which RU Allocation subfield in the Common field of the SIG field this user is mapped to. This explicit mapping between a given user and a given RU Allocation subfield may be required in the case of a time-domain resource allocation to allow for the scenario where the same frequency resource and/or spatial stream is allocated to different users in different timeslot ranges.

In an embodiment, the Number of Timeslots subfield may be added to the User field to indicate the number of the timeslots allocated to this user. The range of timeslots allocated to a given user may be referenced to the start of the data part in the PPDU if this is the first user in the content channel allocated to a given RU or MRU. The range of timeslots allocated to a given user may be referenced to the last timeslot in the range of timeslots allocated to the previous user mapped to the same RU or MRU.

In an embodiment, the Number of Timeslots subfield along with the RU Allocations subfield and NSS (Number of Spatial Streams) subfield may provide a three-dimensional resource allocation in which a given user is allocated a range of timeslots on a given frequency resource (RU or MRU) on a specific spatial stream(s).

Preemption behavior involves interruption of an ongoing transmission as a response to an unforeseen event which requires an immediate response from the network such as in the case of low latency traffic intended to a non-AP STA in the downlink or an AP STA in the uplink. Preemption implies the rescheduling of a resource which is assigned to a STA in ongoing transmission to reassign it to another STA which may have immediate low latency traffic, for example.

A preempting STA is a STA which may need to transmit or receive low latency traffic and would require the non-AP STA or AP STA to perform a preemption procedure to free up a resource for the low latency traffic to be transmitted.

A preempted STA is a STA which has an ongoing transmission which may get interrupted by the AP or the non-AP STA and have its transmission rescheduled for a later transmission.

In an embodiment, an ongoing downlink transmission may be interrupted by the AP to free up transmission resources to be able to serve an immediate low latency traffic in the downlink. This behavior may be referred to as Downlink Preemption.

In an embodiment, an ongoing uplink transmission may be interrupted by the AP or non-AP STA to free up transmission resources to be able to serve immediate low latency traffic in the uplink. This behavior may be referred to as Uplink Preemption.

In an embodiment, the preemption may be performed by interrupting a SU-PPDU transmission or a MU-PPDU transmission either in the form of OFDMA transmission, MIMO transmission or a combination of both.

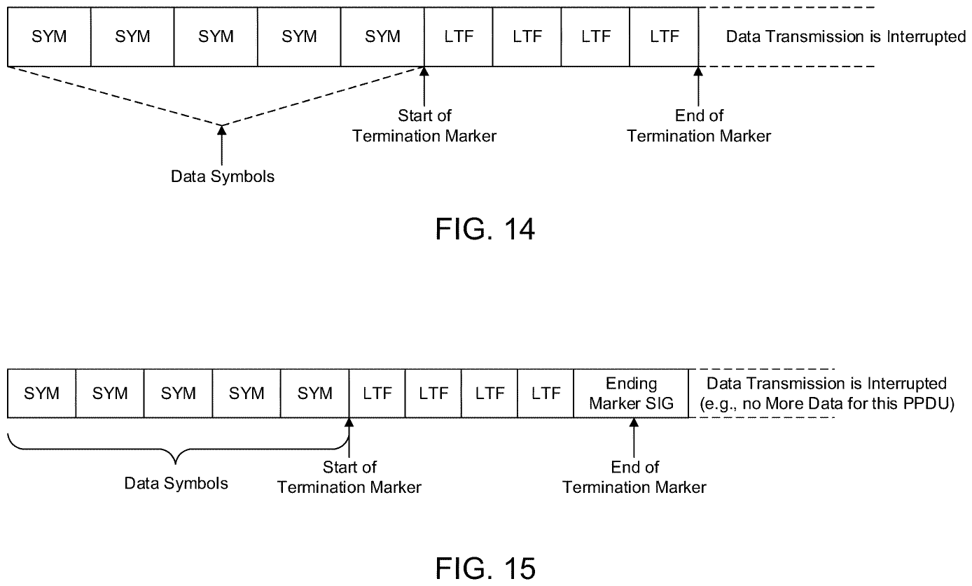

In an embodiment, an AP where low latency (LL) traffic for one or more of its associated STAs is received in the downlink or the non-AP STA that received an indication of LL traffic for itself in the uplink may interrupt the ongoing transmission by inserting a Termination Marker, as shown in FIG. 13. The Termination Marker may be inserted after the transmission of the current OFDM symbol which may be immediately after receiving the indication of low latency traffic. The Termination Marker may be comprised of a set of long training field (LTF) symbols, masked LTF symbols by a known mask or function, or any other special type of symbols with a certain known sequence to differentiate it from data symbols, as shown in FIG. 14. The data transmission may get interrupted and stopped after the Termination Marker and a new transmission may resume after a SIFS such that the STA which is the TXOP holder may keep holding the channel.

In an embodiment, a STA (e.g. AP or non-AP) which is the TXOP holder may resume the transmission a SIFS or any Inter Frame Space (IFS) after the transmission of the Termination Marker. As shown in FIG. 13, the transmission may resume by transmitting a new PPDU with a new header addressed to one of the preempting STAs which has Low Latency (LL) traffic arrived at the AP (e.g., LL PPDU 1). The AP may then send other PPDUs sequentially and separated with a SIFS or any other IFS and addressed to other preempting STAs with LL traffic (e.g., LL PPDU 2). After the AP transmits all LL traffic to the Preempting STAs, the AP may resume the original transmission of the PPDU at the point where the original PPDU transmission of the Preempted STA is interrupted or restart the transmission from the beginning of the PPDU within the TXOP duration which is previously held by the AP. In case of non-AP STA, the non-AP STA may transmit the LL traffic in a new PPDU a SIFS after the Termination Marker sent to the AP by itself. The new PPDU may comprise the LL traffic only or it may also aggregate the LL traffic with the original data aggregated in A-MPDU(s). The non-AP STA may also resume the transmission of the original data in a subsequent PPDU transmitted a SIFS after the LL traffic of the PPDU and within the TXOP duration which is previously held by the non-AP.

In an embodiment, as shown in FIG. 14, the Termination Marker may be comprised of a set of LTF symbols, masked LTF symbols by a known mask or function, or any other special type of symbols with a certain known sequence to differentiate it from data symbols and to indicate the interruption of the original transmission. The Preempted STA may stop the reception procedure and the STAs with LL traffic may identify that a preemption procedure is going to start, and the current transmission is interrupted. For the STA to keep holding the channel, the STA (AP or non-AP) may need to start a new transmission a SIFS after the end of the Termination Marker.

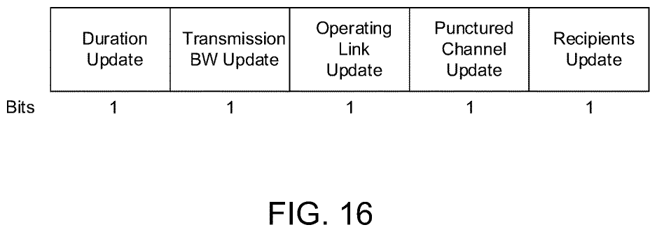

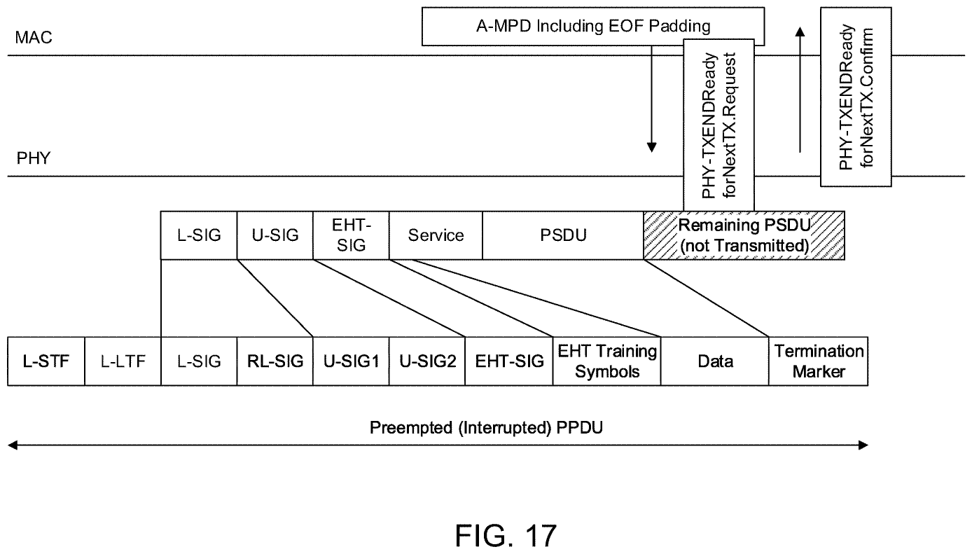

An ending signal (e.g., an Ending Marker SIG) may be added to the end of the Termination Maker, as shown in FIG. 15. FIG. 16 shows an example design of an Ending Marker SIG. The following fields are examples that may be included in the Ending Maker SIG.

A duration update field may be included in the Ending Marker SIG. The duration update field may indicate if the duration will be updated in the header of the next PPDU which carries the low latency traffic (e.g. LL PPDU). For example, one bit may be used for the Duration Update field, and a value of 1 for example may indicate that the transmission duration will be changed from the one originally set for the interrupted PPDU (i.e. the Duration subfield and/or TXOP subfield will be updated). A different value, for example a value of 0, may indicate that the transmission duration will not be changed (i.e. the Duration subfield and/or TXOP subfield will not be updated).

A transmission BW update field may be included in the Ending Marker SIG. The transmission BW update field may indicate if the transmission bandwidths or number of occupied subchannels/channels (e.g. adding one more subchannels/channels or reducing one more subchannels/channels) will be updated in the next PPDU which carries the low latency traffic (e g. LL PPDU). For example, one bit may be used for the transmission BW update field. A value of 1 for example may indicate that the transmission bandwidth (or number of subchannels/channels) used for LL PPDU will be updated. A different value, for example a value of 0, may indicate the transmission bandwidth (or number of subchannels/channels) used for the PPDU that carries LL traffic will not be updated.

An Operating Link Update field may be included in the Ending Marker SIG. The Operating Link Update field may indicate if the transmission link will be updated (e.g. adding more links or reducing operating links) for the next PPDU which carries the low latency traffic (e.g. LL PPDU). For example, one bit may be used for the Operating Link Update field. A value of 1 for example may indicate that the operating link(s) used for LL PPDU will be updated (e.g. more links or fewer number of links will be used). A different value, for example a value of 0, may indicate the operating link(s) used for LL PPDU will not be updated (i.e. same as the ones used in this interrupted PPDU).

A Punctured Channel Update field may be included in the Ending Marker SIG. The Punctured Channel Update field may indicate if a punctured channel pattern will be updated (e.g. punctured more or fewer number of subchannels) for the next PPDU which carries the low latency traffic (e.g. LL PPDU). For example, one bit may be used for the Punctured Channel Update field. A value of 1 for example may indicate that the punctured pattern used for LL PPDU will be updated (e.g. more or fewer number of subchannels will be punctured compared with the ones used in this interrupted PPDU). A different value, for example a value of 0, may indicate the punctured channel pattern used for LL PPDU will not be updated (i.e. same as the ones used in this interrupted PPDU).

A Recipients Update field may be included in the Ending Marker SIG. The Recipients Update field may indicate if the recipients or the number of recipients in the following PPDU which carries the low latency traffic (e.g. LL PPDU), will be changed or not. For example, one bit may be used for the Recipients Update field. A value of 1 for example may indicate the recipients or the number of recipients in the following LL PPDU will be different from this interrupted PPDU. A different value, for example a value of 0, may indicate the recipients or the number of recipients in the following LL PPDU is same as the ones indicated in this interrupted PPDU.

In an embodiment, the MAC layer of the transmitter STA may indicate to the PHY layer of the transmitter STA that the transmission of the current PPDU needs to be terminated and switched for the transmission of another PPDU which may carry different type of data (e.g. low latency traffic). For example, in this case, the transmission of the ongoing PSDU may be prematurely terminated by the MAC through a primitive, for example, PHY-TXEND-ReadyforNextTX.request. PHY-TXSTART may be disabled by the issuance of the PHY-TXEND-ReadyForNextTX.request. On the reception of the PHY-TXEND-ReadyForNextTx.request, the PHY may need to send a PHY-TXENDReadyforNextTX.confirm primitive to the MAC, start to generate a Termination Marker, and switch to a TX state to wait for the MAC signaling, for example, PHY-TXSTART.request primitive for the next PPDU transmission. FIG. 1 (Preemption_TxStateProcedure) shows an example PHY layer transmit procedure of a preempted, or interrupted, PPDU assuming that the ongoing interrupted transmission is a EHT MU PPDU transmission. The interrupted PPDU may be any other type of PPDU. Note that the MAC layer may send PHY-TXEND-ReadyForNexTx.request at any time of the PSDU transmission.

If any of above fields are set to a particular value, for example a value of 1, the recipient STA may need to monitor the updated Duration (or TXOP) and/or Transmission BW and/or Operating Link and/or number of recipients in the next coming LL PPDU.

In an embodiment, the preamble of the LL PPDUs (e.g. LL PPDU1 and LL PPDU2) may be a short preamble comprising (e.g. only comprising) enhanced synchronization fields, enhanced channel estimation fields, and enhanced SIG fields. The preamble of the LL PPDUs may also be a long preamble comprising the legacy fields.

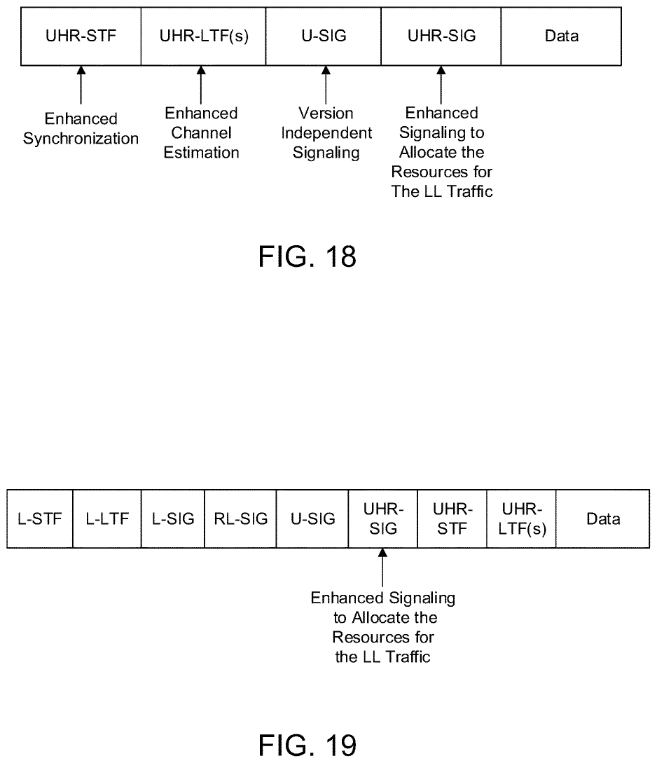

In an embodiment, the short preamble may comprise of a UHR-STF field, a UHR-LTF field, a U-SIG field, and a UHR-SIG field. The UHR-STF field may be used by the preempting STAs to synchronize with the AP and to improve the automatic gain control. The UHR-LTF(s) field may be used by the preempting STA to perform enhanced channel estimation. The U-SIG field may comprise version-independent information which is universal and may be decoded by legacy STAs or by future amendment STAs. FIG. 18 shows an example design of the short preamble for a preempting transmission. The UHR-SIG field may indicate the signaling information necessary for the intended preempting STA to receive the data which may be sent after (e.g. immediately after) the UHR-SIG, as shown in FIG. 18.

FIG. 19 shows an example design of the long preamble for a preempting transmission. In an embodiment, the long preamble may comprise the legacy fields (e.g. L-STF, L-LTF, L-SIG, RL-SIG, and U-SIG) and the new fields such as the UHR-SIG field, the UHR-STF field and UHR-LTF(s) field, as shown in FIG. 19.

In an embodiment, the Termination Marker may comprise synchronization sequences (such as STF and LTF) and may be used by the listening or monitoring preempting STAs for initial synchronization. The preempting STAs may use the enhanced short preamble fields, as shown in FIG. 18, for fine synchronization purposes.

In an embodiment, the STA (e.g. AP or non-AP) that is the TXOP holder may transmit the LL traffic of the preempting STA(s) (e.g. LL Data 1 and LL Data 2) and resume the transmission of the original PPDU of the preempted STA such that the entire transmission may not exceed the TXOP duration which is signaled in the SIG field(s) of the original PPDU before interrupting the transmission and was used for the NAV setting in the BSS. The STA (AP or non-AP) shall guarantee that no transmission may take place outside the TXOP duration such that other STAs which are not involved in the preemption event, (neither the preempting STA(s) nor the preempted STA(s), do not get confused by changes in the media which are not signaled to them.

In an embodiment, the NAV setting for the LL PPDUs addressed to the preempting STAs may consider the original TXOP duration set for the original PPDU of the preempted STA(s) which may be obtained for example, by Equation 1. The STA (AP or non-AP) that is the TXOP holder may compute, calculate, or determine the remaining time in the TXOP duration after the termination of the ongoing transmission addressed to the preempted STA and set the NAV accordingly. The TXOP calculations may consider the time used to send a part of the original PPDU of the preempted STA, the time used to send the Termination Marker, and the time used in any IFS after the Termination Marker and before the transmission of the first or the sole LL PPDU.

$${NAV}_{first} = {T}_{TXOP} - {T}_{Header} - {T}_{PPDU} - {T}_{TerminationMarker} - IFS \qquad ( Equation 1 )$$

In equation 1, NAV_{first} is the NAV of the first or the sole LL PPDU that will be transmitted in the preemption event, T_{TXOP} is the duration of the original TXOP which is held by the STA (AP or non-AP) and signaled in the header of the original PPDU transmission addressed to the Preempted STA, T_{Header} is the time used to transmit the header of the first or the sole LL PPDU and T_{PPDU} is the time used to transmit the portion of the data which is transmitted before the interruption of the transmission, T_{TerminationMarker} is the time used to transmit the Termination Marker and IFS is the Inter Frame Spacing after the Termination Marker and before the header of the first or the sole LL PPDU.

In an embodiment, the NAV setting of any subsequent LL PPDU may consider the time computed in NAV_{first} and the time used to transmit any previous LL PPDU(s) and the IFS in between them, if any, for example as formulated in Equation 2.

$${NAV}_{i} = {NAV}_{i - 1} - {T}_{{Header}_{i - 1}} - {T}_{LL - {PPDU}_{i - 1}} \qquad ( Equation 2 )$$

In equation 2, NAVᵢ is the NAV setting of the LL PPDU i, T_{Header}_{ᵢ₋₁} is the time used to transmit the header of the previous LL-PPDU and T_{LL-PPDU}_{ᵢ₋₁} is the time used to transmit the data portion of the LL traffic.

In an embodiment, the STA (AP or non-AP) that is the TXOP holder may use the entire remaining time in the TXOP duration to transmit LL traffic and may contend later for the channel to resume the transmission of the original PPDU which was addressed to the Preempted STA.

In an embodiment, the STA (AP or non-AP) that is the TXOP holder may resume the transmission of the original PPDU which was addressed to the preempted STA by continuing the transmission of the remaining OFDM symbols starting at the OFDM symbol just before the Termination Marker. In an embodiment, the AP may restart the transmission of the entire original PPDU either in the same TXOP or a subsequent TXOP.

In an embodiment, the STA (AP or non-AP) that is the owner of the TXOP may use one or more bits in the UHR-SIG field or any other SIG field to indicate if the transmitted PPDU is preemptible or is not preemptible. A subfield named, for example, Preemptible may be included in the SIG field such that this field may be set to a particular value, for example a value of 1, to indicate the current PPDU is Preemptible and may be set to a different value, for example a value of 0, to indicate that the current PPDU is non-Preemptible. A Preemptible PPDU is a PPDU that may be interrupted if low latency traffic is received and may be terminated by a Termination Marker. A non-Preemptible PPDU is a PPDU that cannot be interrupted by any means and for any reason. A non-Preemptible PPDU is the default type of PPDUs which is the type of PPDUs transmitted in 802.11 legacy amendments. The Preemptible subfield may be used as an early notification for STAs that support Preemption behavior such that those STAs may behave differently if the PPDU is marked as Preemptible or non-Preemptible.

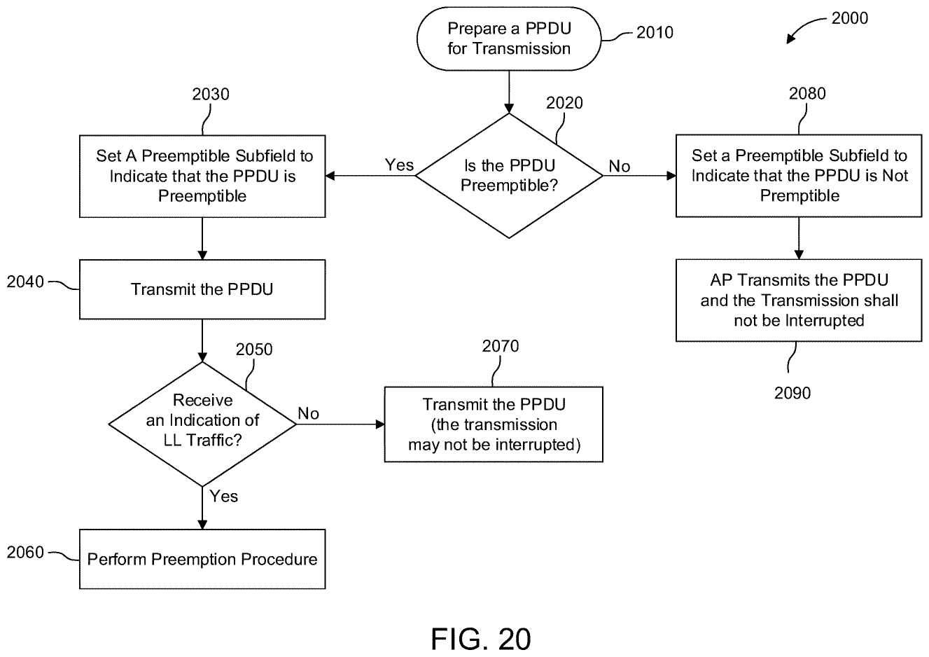

FIG. 20 shows an example of a preemption procedure for a transmitter 2000. In an embodiment, a STA (e.g. an AP STA or a non-AP STA) may prepare a PPDU for transmission 2010. The STA may determine whether the PPDU is preemptible 2020. If the PPDU is preemptible, the STA may set a Preemptible subfield in, for example a SIG field, to indicate that the PPDU is preemptible and that the transmission of this PPDU may be interrupted 2030. For example the STA may set the Preemptible subfield to a value of 1 to indicate that the PPDU is preemptible. The STA may transmit the PPDU with the Preemptible filed set to indicate that the PPDU is preemptible 2040. If the PPDU is preemptible and the STA receives an indication of LL traffic 2050, the STA may interrupt the transmission of the PPDU and prepare for the transmission of the LL traffic and perform a preemption procedure. If the STA does not receive an indication of LL traffic, the STA may transmit the PPDU and the transmission may not be interrupted 2070. If the STA determines that the PPDU is not preemptible, the STA may set the Preemptible subfield to indicate that the transmission of this PPDU may not be interrupted 2080. For example, the STA may set the Preemptible subfield to a value of 0 to indicate that the PPDU is not preemptible. If the PPDU is not preemptible and the STA receives an indication of LL traffic, the STA may proceed with the transmission of the PPDU and may not interrupt the transmission 2090.

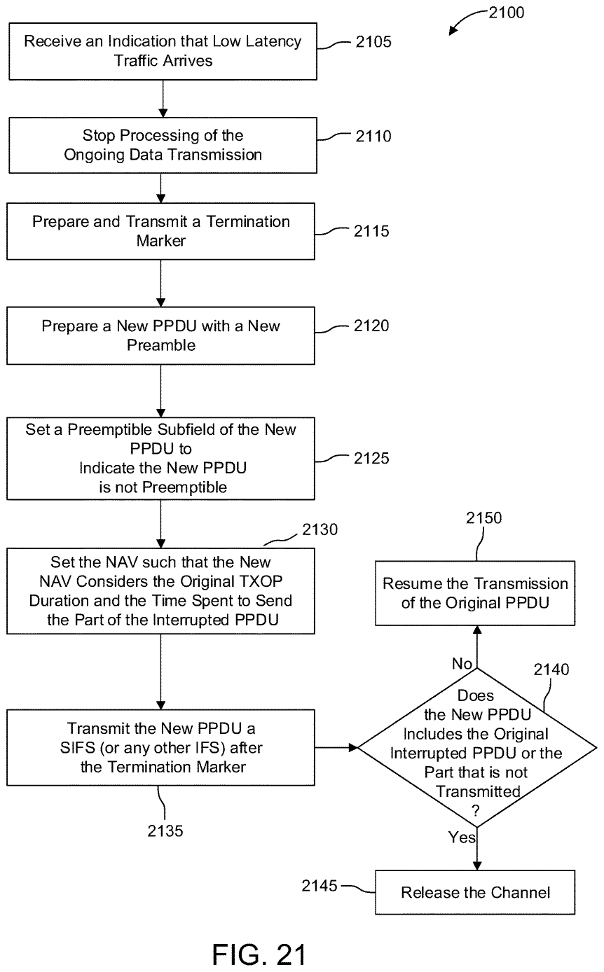

FIG. 21 shows an example method of a transmitter behavior for a preemption procedure 2100. In an embodiment, a STA (e.g. an AP STA or non-AP STA) may receive an indication that LL traffic arrived for one or more associated non-AP STAs in the downlink (in case of an AP STA) or receive an indication of uplink LL traffic for itself (in case of a non-AP STA) 2105. In response to the LL traffic indication, the STA may stop processing of the ongoing transmission 2110. The STA may prepare and transmit a Termination Marker after (e.g. immediately after) the transmission of the current OFDM symbol of the ongoing transmission 2115. The STA may prepare a new PPDU 2120. The new PPDU may comprise a new preamble. The new PPDU may carry the low latency traffic for one or more associated non-AP STAs (in case of an AP STA transmitting in the downlink) and may also comprise some or all of the data in the original PPDU which is interrupted to transmit the LL traffic. In case of a non-AP STA, the STA may prepare a new PPDU with a new preamble which may carry the low latency traffic of itself and also may carry a part or all of the data in the original PPDU which is interrupted to transmit the LL traffic. The STA may set a Preemptible subfield in the SIG field of the new PPDU to a value (e.g. value of 0) to indicate that this new PPDU is not Preemptible 2125. The STA may set the NAV 2130 such that the new NAV considers the original TXOP duration and the time spent to send the part of the interrupted PPDU. The end of the new TXOP duration may be aligned to the end of the original TXOP duration. The STA may transmit the new PPDU a SIFS (or any other IFS) after the Termination Marker 2135. If the new PPDU includes the data of the original interrupted PPDU 2140, then the STA may release the channel if there is no more data to transmit 2145. If the new PPDU does not include the data of the original interrupted PPDU 2140, the STA may resume the transmission of the data of the original interrupted PPDU 2150. The STA may transmit the remaining part of the data or may transmit the entire original PPDU.

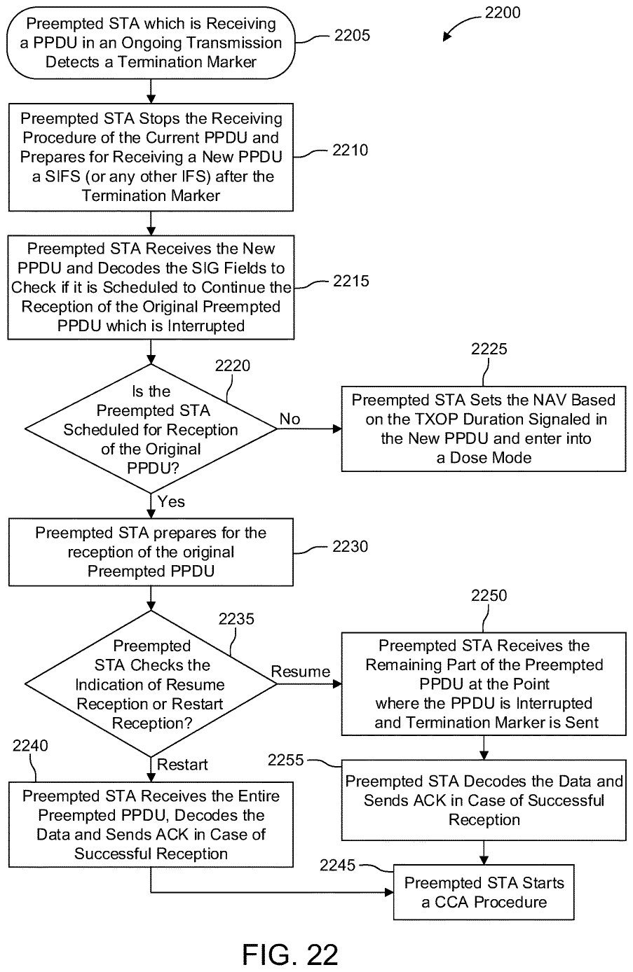

FIG. 22 shows an example method of a preempted STA receiver behavior 2200. In an embodiment, a Preempted STA (AP STA or non-AP STA), which is in a state of receiving a PPDU in an ongoing transmission, may detect a Termination Marker 2205. The Preempted STA may stop the receiving the current PPDU and prepare for receiving a new PPDU a SIFS (or any other IFS) after the Termination Marker 2210. The Preempted STA may receive the new PPDU 2215. and the Preempted STA may decode the SIG field(s) 2220. The Preempted STA may determine, based on the decoded SIG field(s), if it is scheduled to continue the reception of the original Preempted PPDU which is interrupted 2220. If the Preempted STA is not scheduled to continue receiving the original Preempted PPDU, it may set the NAV counter and enter into a dose mode 2225. If the Preempted STA is scheduled in the new PPDU, it may prepare for the reception of the original interrupted data (Preempted PPDU) 2230. The Preempted STA may check an indication of resume reception or restart reception in the SIG field(s) 2235. The SIG field(s) may be SIG fields of the PPDU which resumes the transmission of the original PPDU. If the Preempted STA receives an indication of restart reception, the Preempted STA may receive the entire preempted PPDU, decode the data, and send an ACK in case of a successful reception 2240. The Preempted STA may start a clear channel assessment (CCA) procedure 2245. The CCA may be used for determining whether the medium is idle or not. The CCA may include carrier sensing and energy detection. A Carrier Sense (CS) procedure may comprise a physical CS and a virtual CS (NAV setting). If the Preempted STA receives an indication of resume reception, the Preempted STA may receive the remaining part of the Preempted PPDU at the point where the PPDU is interrupted and where the termination marker is sent 2250. The Preempted STA may decode the data and send an ACK in the case of a successful reception 2255.

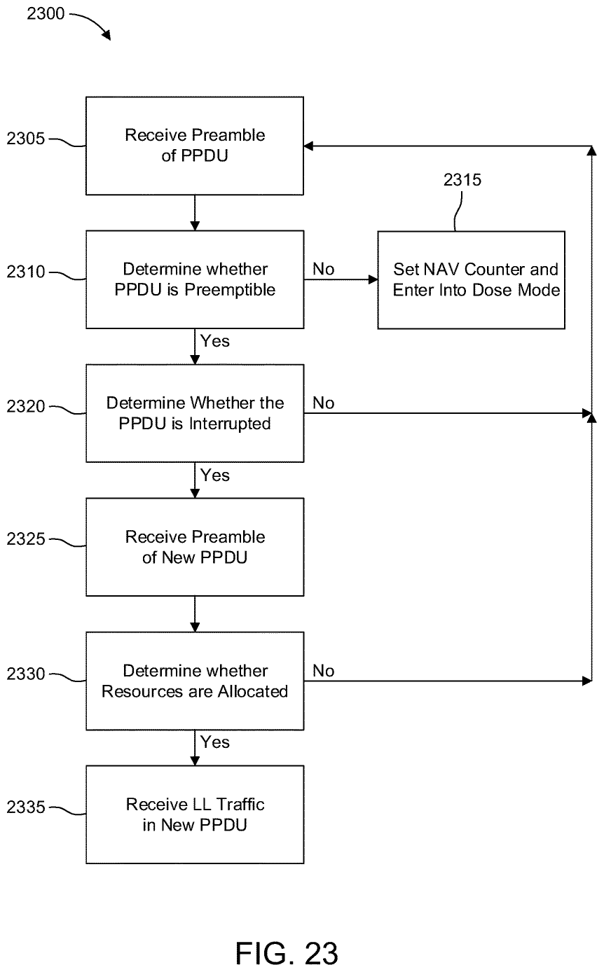

FIG. 23 shows an example method of a preempting STA receiver behavior 2300. In an embodiment, a Preempting STA (AP STA or non-AP STA) may receive a preamble of a PPDU (e.g. a normal PPDU) which is transmitted in an ongoing transmission 2305. The Preempting STA may determine whether the PPDU is preemptible 2310. The Preempting STA may determine whether the PPDU is preemptible by checking a Preemptible subfield in a SIG field of the preamble. For example, the Preemptible subfield set to 0 may indicate that the PPDU is not preemptible. If the Preemptible subfield is set to 0 (i.e. indicating that the PPDU is not preemptible), the Preempting STA may set the NAV counter and may enter into a dose mode 2315. The Preemptible subfield set to 1 may indicate that the PPDU is preemptible. If the Preemptible subfield is set to 1 (i.e. indicating that the PPDU is preemptible), the Preempting STA may determine whether the ongoing PPDU transmission is interrupted 2320. The Preempting STA may determine that the ongoing PPDU transmission is interrupted if it finds a Termination Marker. A Termination Marker may be comprised of a set of LTF symbols, masked LTF symbols by a known mask or function, or any other special type of symbols with a certain known sequence to differentiate it from data symbol, as shown, for example, in FIG. 14 and FIG. 15.

In an embodiment, the Preempting STA may receive and decode the entire ongoing PPDU transmission and look for a Termination Marker. In this embodiment, the Termination Marker may be inserted at any point of the data transmission of the Preemptive ongoing transmission if LL traffic is received.

In another embodiment, the Preempting STA may receive and decode the preamble of the PPDU and decode every Nth OFDM symbol of the data part to look for a Termination Marker start. In this embodiment, the Termination Marker may be inserted at specific points of the data transmission of the Preemptive ongoing transmission if LL traffic is received. These points may be at one of the Nth OFDM symbols of the data part. For example, the Termination Marker may be inserted at the 10th OFDM Symbol, the 20th OFDM Symbol, the 30th OFDM symbol, and so on.

If the Preempting STA determines that the PPDU is not interrupted (e.g. it does not find the Termination Marker), it may perform a CCA procedure. If the Preempting STA determines that the PPDU is interrupted (e.g. it finds the Termination Marker), it may receive the Termination Marker and decodes it if any signaling information is attached to it, for example the ending marker SIG shown in FIGS. 15 and 16. The Preempting STA may receive, after a SIFS (or any other IFS) and decode a preamble of the new PPDU to determine whether the Preempting STA is allocated resources for itself 2325. If the Preempting STA is not allocated resources in the new PPDU 2330, it may perform a CCA procedure. If the Preempting STA is allocated resources in the new PPDU 2330, it may receive the LL traffic transmitted in the new PPDU and decode the LL data addressed to itself 2335.

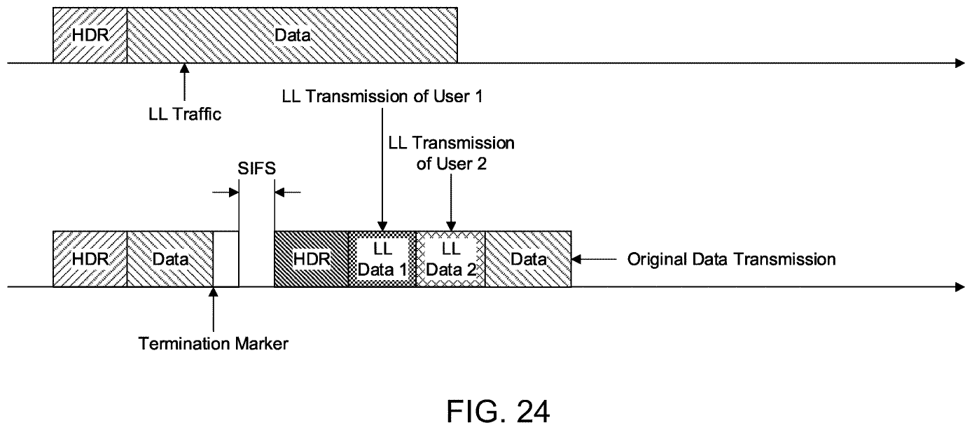

FIG. 24 shows an example of preemption with time-domain allocation of low latency traffic In an embodiment, the transmission of low latency traffic after the termination of an ongoing transmission may consider the allocation of time domain resources for all the STAs with low latency traffic in the same PPDU, as shown in FIG. 24. In this resource allocation scheme, the entire BSS bandwidth may be allocated to one Preempting STA for a time duration such that the time needed to transmit the LL traffic intended to this STA be minimized. Also, this allocation scheme may efficiently use the airtime since only one header may be used for the MU-PPDU which may carry the data addressed to different Preempting STAs (e.g. LL Data 1 and LL Data 2) and may also carry the original packet addressed to the Preempted STA and is interrupted by the Preemption event.

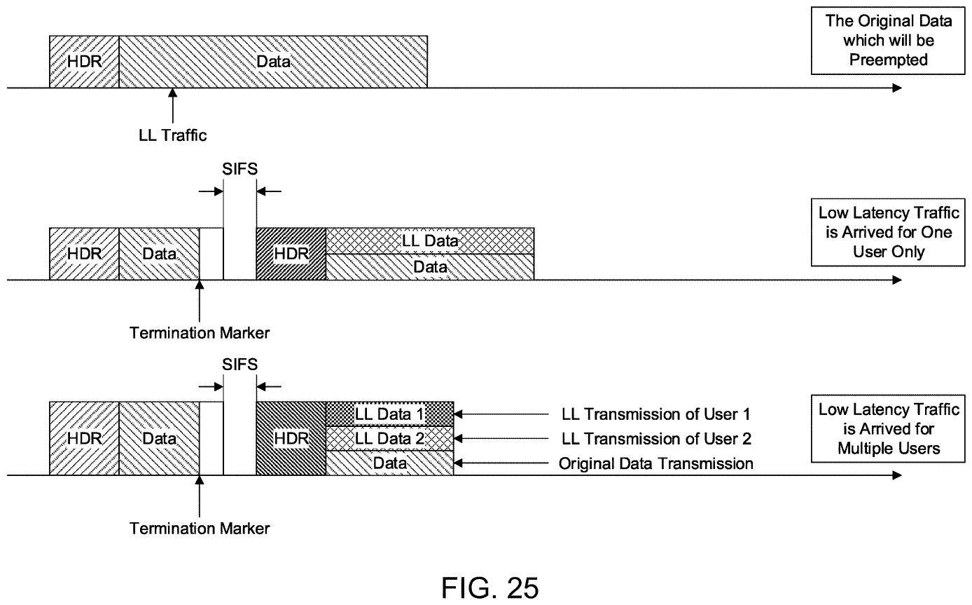

FIG. 25 shows an example of preemption with frequency-domain allocation (MU-PPDU) of low latency traffic. In an embodiment, the transmission of low latency traffic after the termination of the ongoing transmission may consider the allocation of frequency domain allocations, as shown in FIG. 25. In this resource allocation scheme, the original PPDU which is interrupted by the Preemption event may be included in a new MU-PPDU transmission which may allocate different Resource Units (RUs) or Multi-Resource Units (MRUs) to the Preempting STAs and to the Preempted STA.

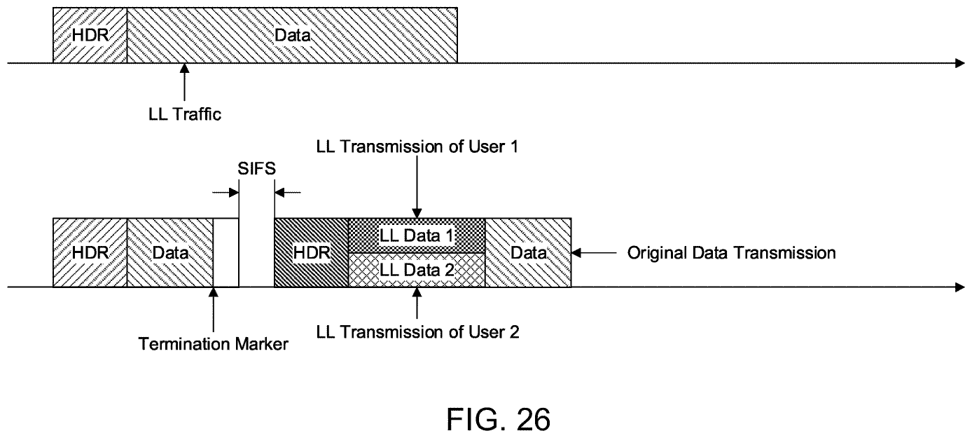

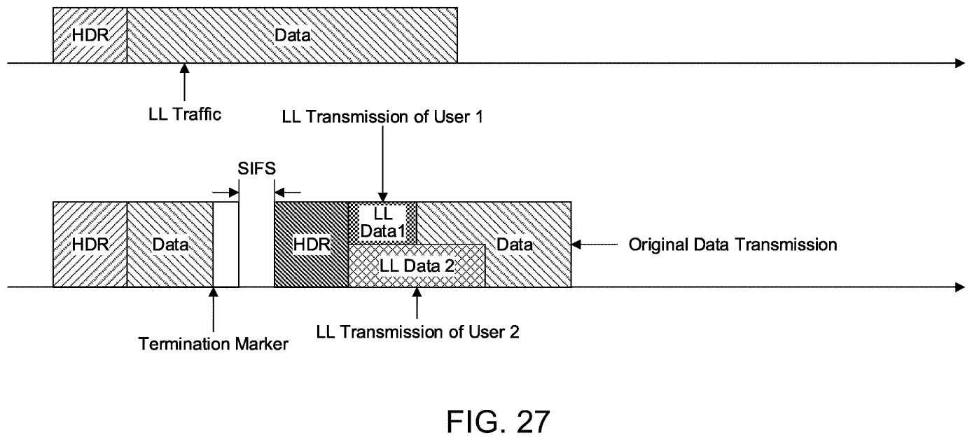

FIG. 26 and FIG. 27 shows example of preemption with frequency-domain and time-domain allocation (MU-PPDU) of low latency traffic. In an embodiment, a combination of time domain and frequency domain resource allocation may be used in the transmission of the low latency traffic addressed to the Preempting STAs or the original PPDU addressed to the Preempted STA, as shown in FIG. 26 and FIG. 27.

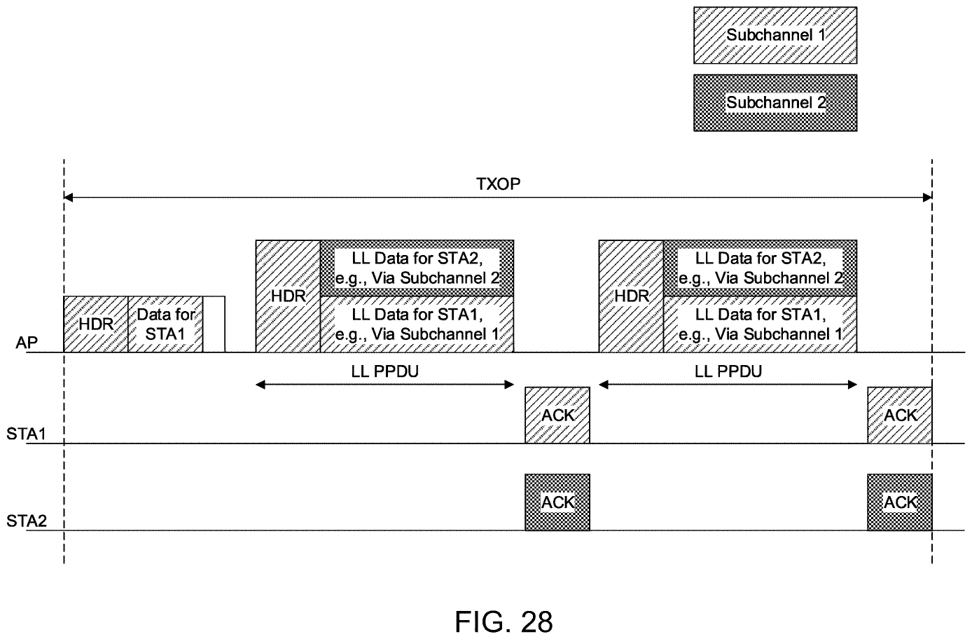

FIG. 28 shows an example of preemption with dynamic bandwidth (BW) update of Low Latency Traffic. In this example, an AP is the TXOP holder and may initially transmit one PPDU that comprises non-LL traffic to STA1. During the transmission of this PPDU, low latency traffic arrives, and the AP may terminate this ongoing transmission that carries non-LL traffic. The low latency traffic is intended for STA1 and STA2. Due to the availability of another subchannel (or channel), the AP may decide to increase the operating bandwidth (or increase the number of subchannels or channels). OFDMA may be performed in the following transmission which carries LL traffic to STA1 and STA2. In this example, a subchannel is assigned to STA1 and a subchannel is assigned to STA2. The HDR of the LL PPDU may indicate the updated operating BW and subchannels allocated to STA1 and STA2, respectively. Once the STAs decode the HDR of the LL PPDU, they know if they are the recipients or not and may send back ACKs to the AP a SIF after the reception of the LL PPDU intended to them. The AP may send another LL PPDU if there is more LL traffic.

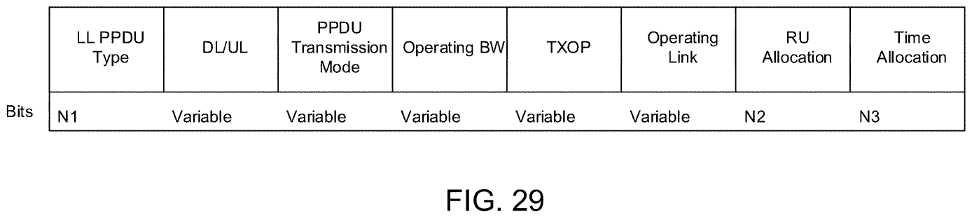

An example UHR-SIG is shown in FIG. 29. In an embodiment, the following information or fields may be included in an UHR-SIG or any other SIG in the PPDU that may carry a low latency PPDU (e.g. LL PPDU).

An LL PPDU type indication may be included in an UHR-SIG. The LL PPDU type indication may indicate if the PPDU includes LL data only (or the data which are not the continuation of the previous transmission) or mixed data that includes both LL traffic and non-LL traffic (or the new data and the data which are the continuation of the previous transmission). For example, N bits may be used for the indication. A particular value, for example N1=1, may indicate that it includes LL data only. A different value may indicate it may include not only LL data but also non-LL data.

A DL/UL field may be included in an UHR-SIG. The DL/UL filed may indicate if it is a DL or an UL transmission. For example, one bit may be used for the DL/UL field. A particular value, for example a value of 0. may indicate that it is a DL transmission and a different value, for example a value of 1, may indicate that it is an UL transmission. If the LL PPDU type indicates it is a LL PPDU, then a particular value, for example DL/UL=0, may indicate that it is a DL LL PPDU and a different particular value, for example DL/UL=1, may indicate that it is an UL LL PPDU.

A PPDU transmission mode field may be included in an UHR-SIG. The PPDU transmission mode field may indicate if it is a SU or MU transmission. MU transmission may include OFDMA or MU-MIMO transmission. To save the number of bits shown in a U-SIG, the PPDU transmission mode field may only be present if the Recipients Update field of the Ending Marking SIG (see FIG. 16) indicates the recipients or the number of recipients is changed from the interrupted PPDU to the LL PPDU. If the Recipients Update field of the Ending Marking SIG (see FIG. 16), indicates the recipients or the number of recipients is not changed from the interrupted PPDU to the LL PPDU, then this field may not be present. Table 2 shows an example description of combination of DL/UL and PPDU Transmission Mode fields.

TABLE 2
Example description of combination of
DL/UL and Transmission Mode fields

| DL/UL | Transmission | |
|---|---|---|
| subfield | Mode field | |
| (1 bit) | (3 bits) | Description |
| 0 | 000 | DL OFDMA (including non-MU-MIMO and |
| | | MU-MIMO). This transmission includes LL |
| | | data only |
| 0 | 001 | DL OFDMA (including non-MU-MIMO and |
| | | MU-MIMO). This transmission includes LL |
| | | data and legacy data which may not contain |
| | | LL traffic. |
| 0 | 010 | DL non OFDMA MU-MIMO. This |
| | | transmission includes LL data only |
| 0 | 011 | DL non OFDMA MU-MIMO. This |
| | | transmission includes LL data and legacy |
| | | data which may not contain LL traffic. |
| 0 | 100 | DL SU transmission which includes LL data |
| | | only |
| 0 | 101 | DL SU transmission which includes LL data |
| | | first and is followed by the legacy data which |
| | | may not contain LL traffic |
| 0 | 110, 111, | Validate |
| 1 | 000 | UL MU Transmission. In this transmission, |
| | | only LL data are included. |
| 1 | 001 | UL MU Transmission. In this transmission, |
| | | LL transmission and legacy TB PPDU that |
| | | carries non-LL traffic are included. |
| 1 | 010 | UL SU Transmission which includes LL data |
| | | only |
| 1 | 011 | UL SU Transmission which includes LL data |
| | | first, followed by the legacy data which may |
| | | not carry LL traffic |
| 1 | 100, 111 | Validate |

An operating BW field may be included in an UHR-SIG. The operating BW field may indicate the operating bandwidth of the LL PPDU. This field may be present in an UHR-SIG to indicate the operating bandwidths used for carrying LL data and the transmission that carriers non LL traffic respectively. To save the number of bits included in an UHR-SIG, the operating BW field may not be present if the bandwidth is only allocated to one type of data (e.g. LL data) and the operating bandwidth is the same as that used in the interrupted PPDU which is transmitted most recently (e.g. immediately before the LL PPDU). For example, the transmission BW update field of Ending Marker SIG (see FIG. 16) indicates that the LL PPDU may not have an operating BW update.

An TXOP field may be included in an UHR-SIG. The TXOP field may indicate the TXOP duration of the LL PPDU. To save the number of bits included in an UHR-SIG, the TXOP field may not be present if the overall TXOP is not different from the duration or TXOP indicated in the most recently interrupted PPDU (e.g. immediately before the LL PPDU). For example, the duration update field of Ending Marker SIG (see FIG. 16) indicates that the LL PPDU may not have a different TXOP as set up by the interrupted PPDU which is transmitted most recently. The TXOP field may be present if the TXOP of the LL PPDU is different from the interrupted PPDU.

An operating link field may be included in an UHR-SIG. The operating link field may indicate the operating link of the LL PPDU. To save the number of bits included in an UHR-SIG, the operating link field may not be present if the operating link is the same as the operating link of the interrupted PPDU which is transmitted more recently (e.g. immediately before the LL PPDU). For example, the operating link update field of Ending Marker SIG (see FIG. 16) indicates that the LL PPDU may not have an operating link update. The operating link field may be present if the operating link(s) of the LL PPDU are different from the ones used in the interrupted PPDU which is transmitted most recently.

An RU allocation field may be included in an UHR-SIG. The RU allocation field may indicate the RU allocation to different recipient STAs which may include the STA(s) that receive LL data and/or the STA(s) that receive data carrying non-LL traffic (e.g. the recipient STA of the interrupted PPDU).

A time allocation field may be included in an UHR-SIG. The time allocation field may indicate the time allocation to different recipient STAs which may include the STA(s) that receive LL data and/or the STA(s) that receive data carrying non-LL traffic (e.g. the recipient STA of the interrupted PPDU).

The fields mentioned above may need to be present if the recipient STA(s) of the LL PPDU are different from the recipient STA(s) of the interrupted PPDU that is most recently transmitted by the STA (e.g. the AP), for example the recipients update field of the Ending Marking SIG (see FIG. 16) indicates that the recipient STAs (or the number of recipient STAs) of the LL PPDU are different from the one present in the interrupted PPDU. Any fields mentioned above may be presented in other SIGs of a PPDU which may or may not comprise low latency traffic.

In an embodiment, a Restart/Resume subfield in the SIG field of the new PPDU transmitted a SIFS after the Termination Marker may be used to indicate for the Preempted STA if the receiving of the original data which is interrupted may be resumed or restarted. If the reception of the original PPDU is signaled to be resumed, the Preempted STA may continue receiving at the next OFDM symbol after the last OFDM symbol which is sent just before the Termination Marker is transmitted. If the reception of the original PPDU is signaled to be restarted, the Preempted STA may restart the reception of the entire interrupted PPDU.

In an embodiment, the preemption procedure may take place in case the ongoing transmission is a MU-PPDU. In this scenario, there may be multiple users scheduled in the ongoing transmission and may not be an efficient procedure to terminate the entire transmission.

In an embodiment, the AP that is the TXOP holder may transmit the Termination Marker on a single RU or MRU, on a single 20 MHz subchannel, or on the entire PPDU bandwidth.

In an embodiment, the AP that is the TXOP holder may send a special SIG field after the Termination Marker to signal the resource allocation to the Preempting STA which is scheduled to receive the LL traffic on the preempted RU or MRU or the subchannel.

In an embodiment, the preemption procedure may be performed in the spatial domain where the Preempting STA may be allocated spatial domain resources along with the other STAs that already scheduled resources in the ongoing transmission. In this case, the AP may need to acquire CSI information for the link with the Preempting STA(s) before the current transmission is taking place.

In an embodiment, an indication of the preemption capability may be included in an UHR PHY Capabilities element or any other element to indicate the capabilities of the STA. If the STA supports the Preemption behavior for the transmitter side and/or receiver side it may indicate this by setting the corresponding capability indication.

In an embodiment, the Preemption Transmitter parameter in the UHR PHY Capabilities element may be set to a value, for example a value of 1, to indicate that the STA supports the transmitter behavior of the Preemption procedure, otherwise the Preemption Transmitter parameter may be set to a different value, for example a value of 0, to indicate that the STA does not support the transmitter behavior of the Preemption procedure.

In an embodiment, the Preemption Receiver parameter in the UHR PHY Capabilities element may be set to a, value, for example a value of 1, to indicate that the STA supports the receiver behavior of the Preemption procedure, otherwise the Preemption Receiver parameter may be set to a different value, for example a value of 0, to indicate that the STA does not support the receiver behavior of the Preemption procedure.

Although the features and elements of the present disclosure are described in the preferred embodiments in particular combinations, each feature or element may be used alone without the other features and elements of the preferred embodiments or in various combinations with or without other features and elements of the present disclosure.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval may be applied in the same solutions.

Although four RBs per triggered TXOP are shown in some figures as an example, the actual number of RBs/channels/bandwidth utilized may vary.

Long Training Field (LTF) may be any type of predefined sequences that are known at both transmitter and receiver sides.

Many procedures are explained from an AP point of view, however it equally applies from the non-AP STA point of view.

Some signaling fields and subfields may be set to 1 or 0 to signal a given indication and may use any other setting of the subfields to signal the same indication.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by station (STA), the method comprising:
receiving a first physical layer protocol data unit (PPDU), wherein the first PPDU comprises a preamble that comprises an indication indicating whether the first PPDU is preemptible;
determining that the first PPDU is preemptible based on the indication;
determining that the first PPDU is interrupted, wherein the first PPDU is interrupted based on a termination marker;
receiving, in response to the first PPDU being interrupted, a second PPDU, wherein the second PPDU comprises a preamble and carries low latency data; and
decoding the second PPDU on a condition that the second PPDU is addressed to the STA.

2. The method of claim 1, wherein the indication indicating whether the first PPDU is preemptible is carried in a preemptible subfield of a SIG field of the preamble of the first PPDU.

3. The method of claim 1, wherein the first PPDU is determined to be interrupted on a condition that a termination marker is found during decoding of the first PPDU.

4. The method of claim 3, wherein the termination marker is comprised of a set of long training field (LTF) symbols or masked LTF symbols by a known mask or function.

5. The method of claim 3, further comprising decoding the first PPDU until a termination marker is found or until an end of the first PPDU.

6. The method of claim 3, further comprising decoding each Nth symbol of a data part of the first PPDU until a termination marker is found or until an end of the first PPDU transmission.

7. The method of claim 1, wherein the second PPDU is received after a time period from a termination marker, wherein the time period is a short interframe space (SIFS).

8. The method of claim 1, further comprising:
receiving an indication of resume or restart of the first PPDU.

9. The method of claim 1, further comprising:
resuming decoding of the first PPDU at a point where the first PPDU was interrupted or restarting decoding of the first PPDU from a beginning based on the indication of resume or restart.

10. The method of claim 1, wherein the STA is a non-access point (AP) STA.

11. A station (STA) comprising:
a transceiver; and
a processor, wherein:
the transceiver is configured to receive a first physical layer protocol data unit (PPDU), wherein the first PPDU comprises a preamble that comprises an indication indicating whether the first PPDU is preemptible;
the processor is configured to determine that the first PPDU is preemptible based on the indication;
the processor is further configured to determine that the first PPDU is interrupted, wherein the first PPDU is interrupted based on a termination marker;
the transceiver is further configured to receive, in response to the first PPDU being interrupted, a second PPDU, wherein the second PPDU comprises a preamble and carries low latency data; and
the processor is further configured to decode the second PPDU on a condition that the second PPDU is addressed to the STA.

12. The STA of claim 11, wherein the indication indicating whether the first PPDU is preemptible is carried in a preemptible subfield of a SIG field of the preamble of the first PPDU.

13. The STA of claim 11, wherein the first PPDU is determined to be interrupted on a condition that a termination marker is found during decoding of the first PPDU.

14. The STA of claim 13, wherein the termination marker is comprised of a set of long training field (LTF) symbols or masked LTF symbols by a known mask or function.

15. The STA of claim 13, wherein the processor is further configured to decode the first PPDU until a termination marker is found or until an end of the first PPDU.

16. The STA of claim 13, wherein the processor is further configured to decode each Nth symbol of a data part of the first PPDU until a termination marker is found or until an end of the first PPDU transmission.

17. The STA of claim 11, wherein the second PPDU is received after a time period from a termination marker, wherein the time period is a short interframe space (SIFS).

18. The STA of claim 11, wherein the transceiver is further configured to receive an indication of resume or restart of the first PPDU.

19. The STA of claim 11, wherein the processor is further configured to resume decoding of the first PPDU at a point where the first PPDU was interrupted or restart decoding of the first PPDU from a beginning based on the indication of resume or restart.

20. The STA of claim 11, wherein the STA is a non-access point (AP) STA.
